(19) United States
(12) Patent Application Publication
(10) Pub. No.: US 2012/0120197 A1
(43) Pub. Date: May 17, 2012

(54) APPARATUS AND METHOD FOR SHARING HARDWARE BETWEEN GRAPHICS AND LENS DISTORTION OPERATION TO GENERATE PSEUDO 3D DISPLAY

(75) Inventors: Dmitry RYUMA, Haifa (IL); Daniel Fishkov, San Jose, CA (US); Erez Galil, Mountain View, CA (US); Shimon Pertsel, Mountain View, CA (US); Chang Liu, San Jose, CA (US)

(73) Assignee: ZORAN CORPORATION, Sunnyvale, CA (US)

(21) Appl. No.: 13/105,813

(22) Filed: May 11, 2011

Related U.S. Application Data
(60) Provisional application No. 61/334,018, filed on May 12, 2010.

(51) Int. Cl. H04N 13/02; H04N 5/217; H04N 5/262

(52) U.S. Cl. 348/46; 348/239; 348/241; 348/E13.074; 348/E05.056; 348/E05.078

(57) ABSTRACT

A system, method, and computer program product for providing pseudo 3D user interface effects in a digital camera with existing lens distortion correction hardware. A distortion map normally used to correct captured images instead alters a displayed user interface object image to support production of a “pseudo 3D” version of the object image via production of at least one modified image. A blending map also selectively mixes the modified image with a second image to produce a distorted blended image. A set or series of such images may be produced automatically or at user direction to generate static or animated effects in-camera without a graphics accelerator, resulting in hardware cost savings and extended battery life.

### CROSS-REFERENCE TO RELATED APPLICATIONS

This application claims the benefit under 35 U.S.C. 119 of provisional application 61/334,018 filed on May 12, 2010 entitled “An Apparatus and Method for Sharing Hardware Between Graphics and Lens Distortion Operation to Generate Pseudo 3D Display” which is hereby incorporated by reference in its entirety. U.S. Pat. Nos. 7,408,576B2 “Techniques for Modifying Image Field Data As A Function Of Radius Across The Image Field” and 7,834,921B1 “Compensation Techniques For Variations In Image Field Data”, are also each hereby incorporated by reference.

### FIELD OF THE INVENTION

This patent application relates in general to user interfaces for digital cameras, and more specifically to providing pseudo 3D user interface effects with existing lens distortion correction hardware.

### BACKGROUND OF THE INVENTION

Recent digital cameras and cell phones provide advanced user interfaces that are based on a “pseudo 3D” look. An example of a popular graphic effect in such a user interface is shown in FIG. 1, which depicts the iPhone® “cover flow” user interface application (iPhone® is a registered trademark of Apple Inc.). This well-known effect enables an intuitive 3D album selector tool that shows a set of images that mimic what a user would see if real 3D objects (e.g. record albums) were being flipped through. Each image depicts an album cover, with the album cover currently being viewed first rotating and translating from a substantially perpendicular set of “shelved” albums, moving to center screen to fully face the viewer, then returning to the shelved set of albums through the rotation and translation effect when the user shifts a point of interest left or right.

Currently the problem of implementing such effects in a digital camera user interface is addressed by integrating dedicated generic graphics cores (such as Open VG or Open GL) into the digital camera's hardware. Then the hardware runs a software layer, typically a Flash utility, that controls the effect display. The graphics core is normally optimized for either vector or triangle operations, but can be adapted to perform the cover flow scenario shown above.

Unfortunately, graphics accelerators don't generally operate on entire images but instead work with multiple graphic sub-units (triangles, polygons, etc.) in parallel, requiring very fast computation and memory access. Significant power consumption is required for this method of user interface implementation. That power consumption limits the battery life of portable devices.

This patent application addresses a more efficient implementation of such an user interface on a digital still camera or video camera system.

### SUMMARY OF THE EMBODIMENTS

Systems, methods, and computer program products for performing user interface effects on a digital camera with lens distortion correction hardware are disclosed and claimed herein. In one embodiment, a method for generating a digital camera user interface comprises modifying at least one input image with lens distortion correction hardware and outputting the modified image. The input image may be a user interface display object image. The modifying step may create pseudo-3D user interface effects including blurring, cover flow, covering, cropping, fading, PageIn, perspective modification, redacting, rotating, stretching, warping, and/or wiping. The modifying further comprises distorting a first image with a distortion map and mixing the distorted first image and a second image with a blending map. The method may operate on an input image or a previously modified image, i.e. the method may execute repeatedly.

The distortion map may be created manually, imported, calibrated in-camera, or created from a predetermined function during a modifying iteration. Distortion maps may be stored in a memory and selectively recalled. Similarly, the blending map may be created manually, imported, and calibrated in-camera. Blending maps may be stored in a memory and selectively recalled. Different distortion maps and/or blending maps may be selected during a modifying iteration. Further, empty spaces resulting from the distorting may be filled with a predetermined color that generates the blending map. The input image and the output modified image may each be a full resolution image or a lower resolution image.

In another embodiment, a method of performing lens distortion correction comprises modifying an image according to a distortion map with a graphics accelerator to remove distortions, and outputting the modified image.

An additional embodiment may include an integrated circuit chip containing circuits configured to perform actions for generating a digital camera user interface comprising modifying at least one input image with lens distortion correction hardware and outputting the modified image. Similarly, a system for generating a digital camera user interface may comprise a lens distortion correction processor configured to modify at least one input image and output the modified image. Finally, a computer program product for generating a digital camera user interface may comprise a machine-readable medium tangibly embodying non-transitory program instructions thereon that, when executed by a computer, cause the computer to modify at least one input image with lens distortion correction hardware and output the modified image.

As described more fully below, the apparatus and processes of the embodiments disclosed permit implementation of user interface effects using lens distortion correction hardware. Further aspects, objects, desirable features, and advantages of the apparatus and methods disclosed herein will be better understood and apparent to one skilled in the relevant art in view of the detailed description and drawings that follow, in which various embodiments are illustrated by way of example. It is to be expressly understood, however, that the drawings are for the purpose of illustration only and are not intended as a definition of the limits of the claimed invention.

### BRIEF DESCRIPTION OF THE DRAWINGS

FIG. 1 depicts a “cover flow” graphical user interface effect;

FIG. 2 depicts a block diagram of an apparatus according to an embodiment;

FIG. 3 depicts a flowchart of a method according to an embodiment; and

FIG. 4 depicts a graphical user interface effect implemented according to an embodiment.

### DETAILED DESCRIPTION OF EXEMPLARY EMBODIMENTS

Embodiments of the present invention use the hardware that already exists in most advanced digital still camera processors for lens distortion correction to perform user interface display effects. For example, the hardware used to correct lens-induced imparities into the image is used according to embodiments of the present invention to enable the “pseudo 3D” effects of the cover flow scenario shown above. Thus two different operational functions may be accomplished with one hardware.

Lens distortion correction hardware is known in the art and is widely used in cameras already. See for example the incorporated references U.S. Pat. Nos. 7,408,578 and 7,834,921. These patents describe that data of an image may be modified by a digital camera, video image capturing device and other optical system to correct for image shading variations appearing in data from a two-dimensional photo-sensor. These variations may be caused by imperfect lenses, non-uniform sensitivity across the photo-sensor, and internal reflections within a housing of the optical system, for example. A small amount of modification data is stored in a small memory within the camera or other optical system in order to correct for these variations. Each primary color may have separate correction data. The modification data may be generated on the fly, at the same rate as the image data is being acquired, so that the modification takes place without slowing down data transfer from the image sensor.

Use of lens distortion correction hardware to implement a rich user interface has the benefits of zero additional hardware cost, as well as significantly lowered power consumption when compared to graphics core based implementations. The performance that can be achieved is also significantly better, as the image processing hardware is better tuned for manipulating images, and it is not required to break the images into graphical primitives.

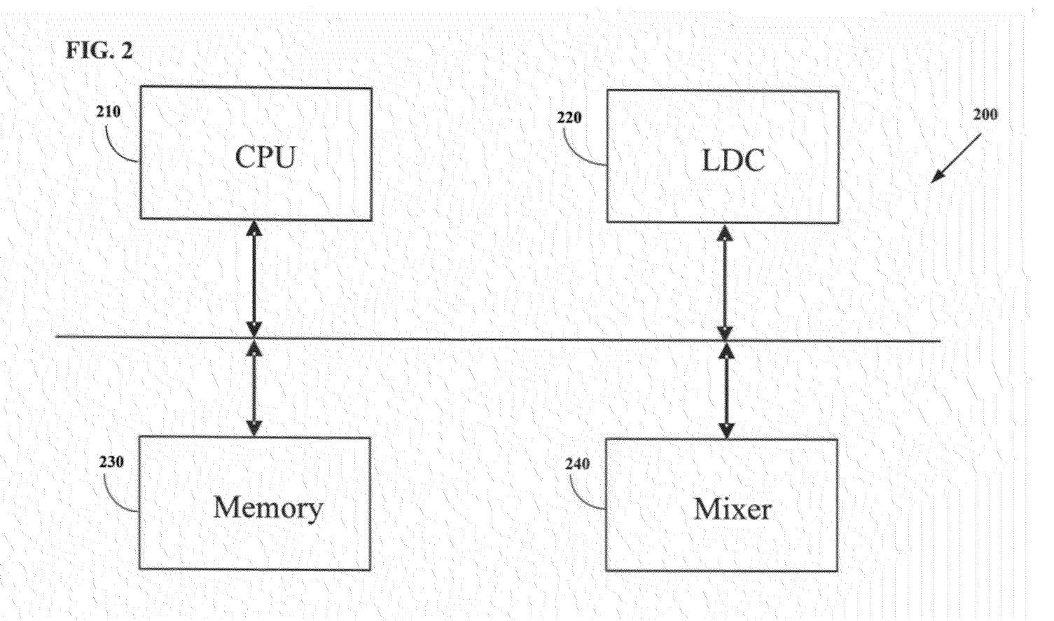

FIG. 2 shows a schematic block diagram 200 of the apparatus according to an embodiment of the invention. The apparatus may be integrated as part of a digital camera that has a lens, a display, and various other optional input and output mechanisms (not shown). The central processing unit (CPU) 210 is responsible for performing the tasks discussed in more detail below. The CPU is coupled to memory 230 that may comprise of various types of memory including, but not limited to, random access memory (RAM), read only memory (ROM), non-volatile memory such as flash memory, and the like. Memory 230 contains instructions that when executed by CPU 210 and other components of the system 200 when applicable, perform the methods discussed herein. In addition, memory 230 contains stored images.

CPU 210 is further coupled to a lens distortion correction (LDC) unit 220. LDC unit 220 receives an image and a distortion map as inputs, generally under the control of CPU 210, both the image and distortion map typically being stored in memory 230. The distortion map normally provides information on how to correct a captured image by causing each pixel's descriptive data to be changed according to a predetermined function. The distortion map could be initially created by any image conversion tool. For example a test pattern of known color and brightness distribution may be photographed, and the resulting image analyzed to detect radial brightness variations or color sensitivity variations across the photo-sensor surface as is known in the art. The distortion map is thus defined by a function that best removes the detected variations. (Lens distortion correction functionality may also be implemented by a graphics accelerator, though this implementation may be disadvantageous as previously described.)

According to embodiments of the present invention however, the distortion map is not used to merely correct a captured image but rather to deliberately create a different kind of distortion that supports production of a desired “pseudo 3D” version of an image. Image effects such as blurring, covering, cropping, fading, redacting, rotating, stretching, warping, wiping, and others readily familiar to those of ordinary skill in the art may thus all be performed in the camera itself, instead of via a separate image processing program that operates on transferred images. Such effects may be applied to full-resolution captured images or to lower-resolution preview versions, which may be adequate for use with user interfaces on camera display panels.

The output provided by LDC unit 220 is an image distorted according to the distortion map and then typically stored in memory 230. It is then necessary to blend, or otherwise mix the distorted image with another image also stored, for example, in memory 230. A mixer unit 240 is responsible for performing such a blending. Mixer unit 240 receives as an input, for example under the control of CPU 210, the distorted image and another image as well as a blending map. The blending map provides information on how the two images should be blended together. For example, the blending map may define what percentage of pixel data in each incoming image goes into an output composite image. Further, the blending may be performed separately for different regions of an image.

For example, after the initial distortion map processing, there may be some troublesome areas on the distorted image that were not in the original image. The blending map may comprise pixels that each have a binary value: either opaque or transparent for example, to help resolve this problem. For an image or image portion of a given geometry, the blending map may be generated with the relevant parts of the image set as opaque. When the blending map is processed by mixer unit 240 using the same distortion function as the one used for the original image, it will alter pixel values accordingly. An appropriate blending map value, e.g. the transparent value, may be configured to fill out the troublesome areas.

The output of mixer unit 240 is a blended image that may be stored in memory 230 for further use. For example, the blended image may be displayed on the display of the apparatus as discussed above. It may further be used to blend with yet another image distorted by LDC unit 220, so the process may repeat as needed, to generate complex or animated effects for example.

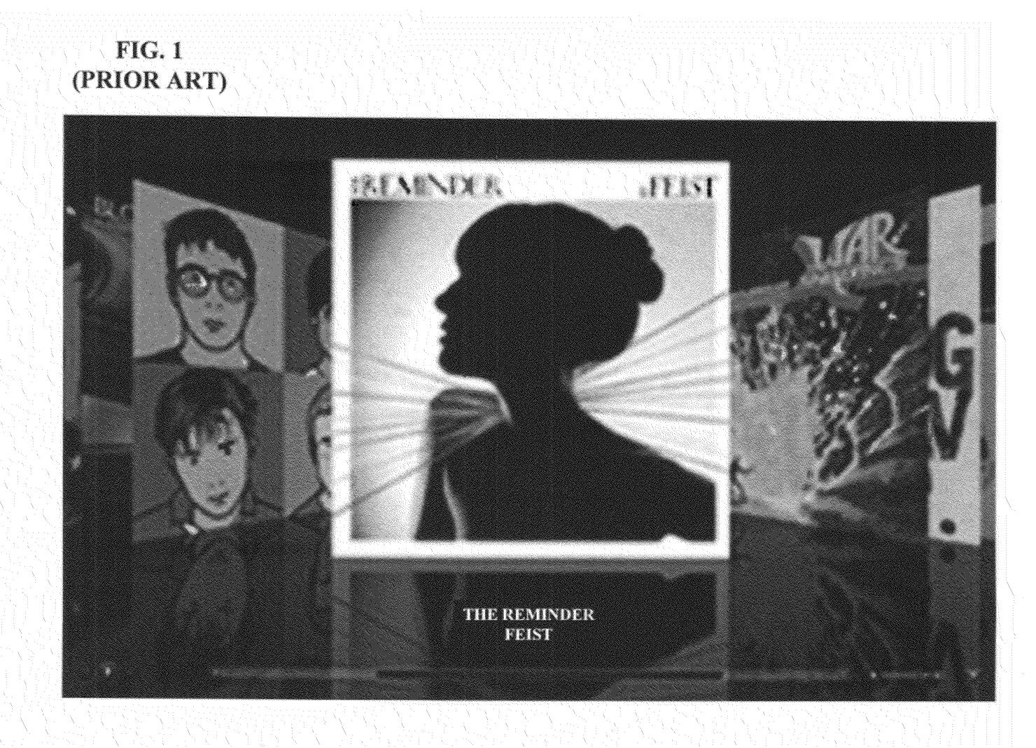

To summarize, embodiments of the present invention generate a distortion map that implements the required perspective mapping. The distortion map can be defined either manually or with a dedicated PC tool that allows more convenient description of the projection. A set of distortion maps may be stored in memory and selected by a user or by embodiments of the invention as needed. The images are then sequentially run through the lens distortion correction block and stored in memory. Later, using mixing hardware, they are applied to the display buffer to produce an output image. Dedicated image processing hardware may also be utilized for scaling and flipping images as needed (for example to implement the reflection effect as shown on FIG. 1). Different buffering schemes may also be implemented as needed.

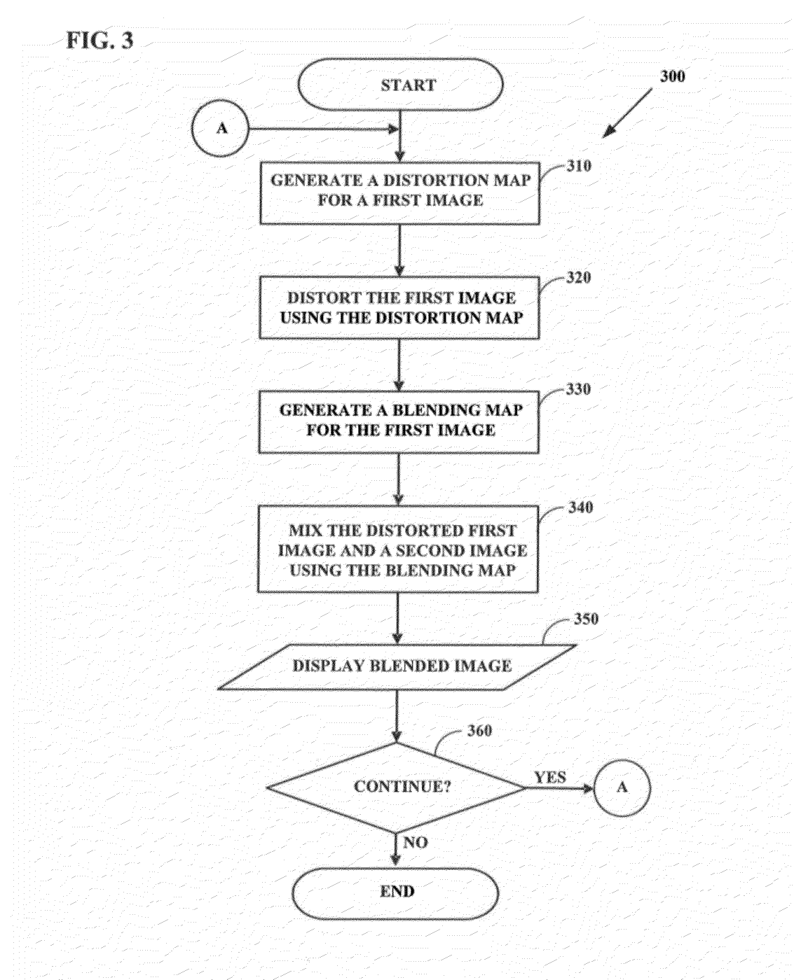

FIG. 3 provides an exemplary and non-limiting flowchart 300 of the operation according to embodiments of the present invention. In step 310, a distortion map is generated for a first image. The distortion map may be prepared, for example, manually, or generated externally to the apparatus described above and transferred thereto, or calibrated on the apparatus. In step 320, the first image is distorted in LDC unit 220 using the distortion map generated in step 310. In step 330, a blending map is generated with the instructions for blending the distorted image from 320 with a second image stored, for example, in memory 230. The blending map may be generated similarly to the way the distortion map is generated. In step 340, mixer unit 240 receives the distorted first image and the second image and blends the two images based on the blending map. In step 350, the blended image is displayed. In step 360, a determination is made whether the process should continue and if so execution continues at step 310; otherwise, execution terminates. It should be noted that for ease of description simple and straightforward actions such as storage and retrieval of images and maps from memory are not discussed with respect to this flowchart. It is expected that a person of ordinary skill in the art would be readily able to implement these steps.

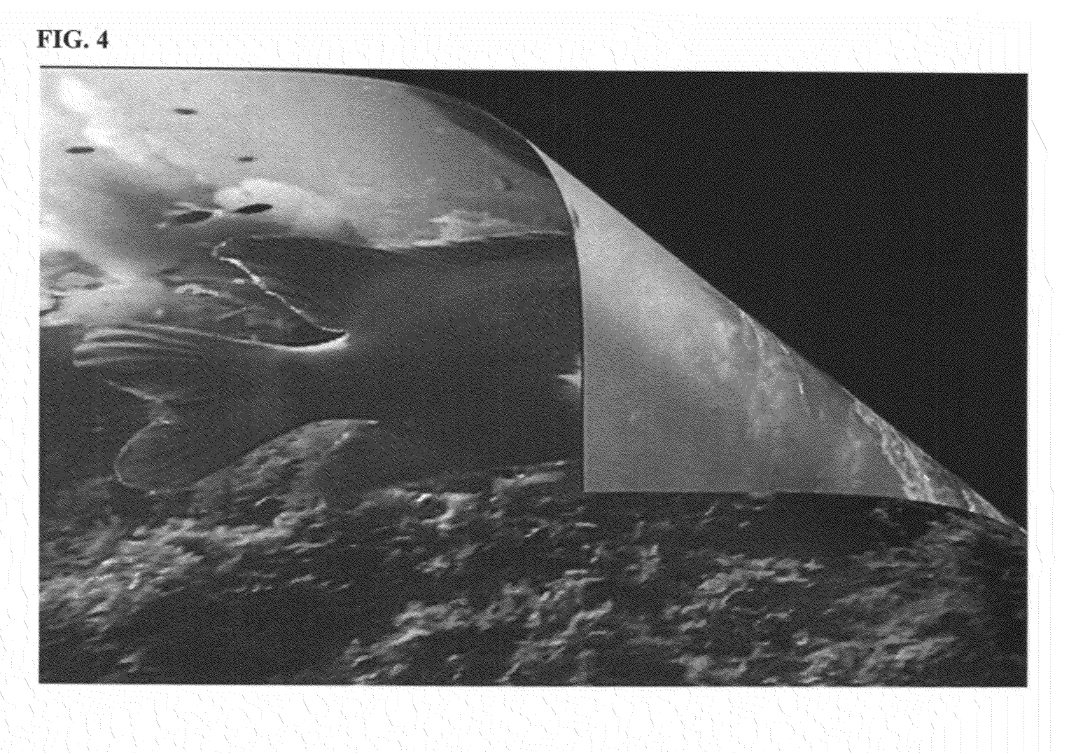

While previewing images in the user interface, transfer to the next image may be implemented using a transfer effect versus simply switching from one image to another. One non-limiting example is the PageIn effect, now described. The currently displayed image is distorted into a shape of the turning of a page, and replaced by the next image. This is done in several steps using for example the process described with respect to FIG. 3. The PageIn effect is statically shown in FIG. 4. Its implementation includes the following steps:
Distorted image=LDC(current image, distortion map of page effect);
New display image=MIX(distorted image, next image, blending map);
Show new display image;
Update distortion and blending map and return to the beginning to achieve the animation effect.

It should be further noted that when distorting an image with LDC unit 220, empty spaces are generated inside the image frame. In one embodiment, the space may be filled by LDC unit 220 with a preconfigured color. This color may be used to generate a blending map, i.e. provide an image of solid color to LDC unit 220 and configure a background color. The output image will then comprise two colors: the original color that refers to the previous image in the example above, while the background color refers to the next image. Then it is possible to convert the output image from LDC unit 220 to the format of the blending map.

Embodiments of the present invention may create effects in a variety of ways. An animator may define an effect by a distortion map that produces desired motion incrementally one frame at a time, so that when the motion is repeated a predetermined sequence results. For example, if a distortion map rotates an object five degrees during each pass through the process, after 72 passes the object will appear to have rotated around completely once. Such an effect may also be run continuously. Alternately, distortion maps may be created frame by frame according to a formulated function; for example, when depicting a falling object the distance traversed by an object per frame may increase predictably with time due to constant acceleration. Finally, a user may define points arbitrarily and allow each frame by frame distortion map to be created by interpolation.

As used herein, the terms “a” or “an” shall mean one or more than one. The term “plurality” shall mean two or more than two. The term “another” is defined as a second or more. The terms “including” and/or “having” are open ended (e.g., comprising). Reference throughout this document to “one embodiment”, “certain embodiments”, “an embodiment” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation. The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

In accordance with the practices of persons skilled in the art of computer programming, embodiments are described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the embodiments are essentially the code segments to perform the necessary tasks. The non-transitory code segments may be stored in a processor readable medium or computer readable medium, which may include any medium that may store or transfer information. Examples of such media include an electronic circuit, a semiconductor memory device, a read-only memory (ROM), a flash memory or other non-volatile memory, a floppy diskette, a CD-ROM, an optical disk, a hard disk, a fiber optic medium, a radio frequency (RF) link, etc. User input may include any combination of a keyboard, mouse, touch screen, voice command input, etc. User input may similarly be used to direct a browser application executing on a user's computing device to one or more network resources, such as web pages, from which computing resources may be accessed.

While the invention has been described in connection with specific examples and various embodiments, it should be readily understood by those skilled in the art that many modifications and adaptations of the invention described herein are possible without departure from the spirit and scope of the invention as claimed hereinafter. Thus, it is to be clearly understood that this application is made only by way of example and not as a limitation on the scope of the invention claimed below. The description is intended to cover any variations, uses or adaptation of the invention following, in general, the principles of the invention, and including such departures from the present disclosure as come within the known and customary practice within the art to which the invention pertains.

What is claimed is:

1. A method for generating a digital camera user interface, comprising:
modifying at least one input image with lens distortion correction hardware; and
outputting the modified image.

2. The method of claim 1 wherein the modifying creates pseudo-3D user interface effects.

3. The method of claim 2 wherein the effects include at least one of blurring, cover flow, covering, cropping, fading, PageIn, perspective modification, redacting, rotating, stretching, warping, and wiping.

4. The method of claim 1 wherein the modifying further comprises:
distorting a first image with a distortion map; and
mixing the distorted first image and a second image with a blending map.

5. The method of claim 4 wherein the first image is one of the input image and a previously modified image.

6. The method of claim 4 wherein the distortion map is at least one of created manually, imported, and calibrated in-camera.

7. The method of claim 4 wherein the distortion map is created from a predetermined function during a modifying iteration.

8. The method of claim 4 wherein at least one distortion map is stored in a memory and selectively recalled.

9. The method of claim 4 wherein the blending map is at least one of created manually, imported, and calibrated in-camera.

10. The method of claim 4 wherein at least one blending map is stored in a memory and selectively recalled.

11. The method of claim 4 wherein at least one of a different distortion map and a different blending map are selected during a modifying iteration.

12. The method of claim 4 wherein empty spaces resulting from the distorting are filled with a predetermined color that generates the blending map.

13. The method of claim 1 wherein the method executes repeatedly.

14. The method of claim 1 wherein the input image is a user interface display object image.

15. The method of claim 1 wherein the input image is one of a full resolution image and a lower resolution image.

16. The method of claim 1 wherein the modified image is one of a full resolution image and a lower resolution image.

17. A method of performing lens distortion correction, comprising:
modifying an image according to a distortion map with a graphics accelerator to remove distortions; and
outputting the modified image.

18. An integrated circuit chip containing circuits configured to perform actions for generating a digital camera user interface comprising:
modifying at least one input image with lens distortion correction hardware; and
outputting the modified image.

19. A system for generating a digital camera user interface, comprising:
a lens distortion correction processor configured to:
modify at least one input image; and
output the modified image.

20. A computer program product for generating a digital camera user interface comprising a machine-readable medium tangibly embodying non-transitory program instructions thereon that, when executed by a computer, cause the computer to:
modify at least one input image with lens distortion correction hardware; and
output the modified image.
